(19) United States
(12) Patent Application Publication
(10) Pub. No.: US 2002/0066640 A1
(43) Pub. Date: Jun. 6, 2002

(54) Apparatus for turning articles

(75) Inventor: Klaus Munsch, Neuwied (DE)

Correspondence Address: FASSE PATENT ATTORNEYS, P.A., P.O. BOX 726, HAMPDEN, ME, 04444-0726, US

(73) Assignee: Winkler & Duennebier AG, Neuwied (DE)

(21) Appl. No.: 09/997,896

(22) Filed: Nov. 30, 2001

(30) Foreign Application Priority Data
Dec. 1, 2000 (DE) 200 20 364.9

(51) Int. Cl. B65G 47/24

(52) U.S. Cl. 198/400

(57) ABSTRACT

The invention relates to a method of, and an apparatus for, turning articles (2), or products and/or semifinished products, during production and/or prior to packaging, in particular hygiene products, using a rotational arrangement (3) which has at least one carry-along element (5) which can be moved relative to the rotational arrangement (3) and receives the article (2) from a feeding transporting arrangement (8) and discharges it again to a continuing transporting arrangement (9).

The core of the invention consists in that the movement direction (12) of the articles (2,2′) which are to be turned and are arranged on the feeding transporting arrangement (8) and the movement direction (14) of the carry-along element (5) at the point in time of, and at the location for (10), receiving the articles and the movement direction (15), the [sic] articles (2) borne by the carry-along element (5) at the point in time of, and at the location for (11), transferring the articles to the continuing transporting arrangement (9) are located at an angle other than zero in each case.

### DESCRIPTION

The invention relates to an apparatus for turning articles or products during or following production or even prior to packaging and, in particular, for turning hygiene products, having the features of the preamble of claim 1.

An apparatus of the abovementioned type is known from DE 4117296 A1. The turning apparatus is located between a feeding transporting arrangement and a continuing transporting arrangement, which are arranged at an angle of 90° in relation to one another. The feeding transporting arrangement discharges the product to the turning arrangement, and said product is then received in the desired position by the continuing transporting arrangement. The two transporting arrangements are located at an angle of 90° in relation to one another, adaptation to different transporting speeds of the two transporting arrangements are also being achieved there with the aid of the turning apparatus.

In relation to this known apparatus, the object of the invention is to increase the possible uses and capability of such an apparatus.

This object is achieved by the features of the characterizing part of claim 1 in that the articles or products are fed to the carry-along element of the apparatus at an angle other than 0° relative to the original movement directions and are discharged from the apparatus into a continuing transporting arrangement at an angle other than 0°.

It is thus possible for the turning apparatus to be installed in rectilinear transporting arrangements, and not just at locations which require the articles or products to continue at an angle of, for example, 90°.

Further features of the invention can be gathered from the subclaims and from the description in conjunction with the drawing.

The invention is described in more detail here below with reference to an exemplary embodiment, which is illustrated in the drawing, in which:

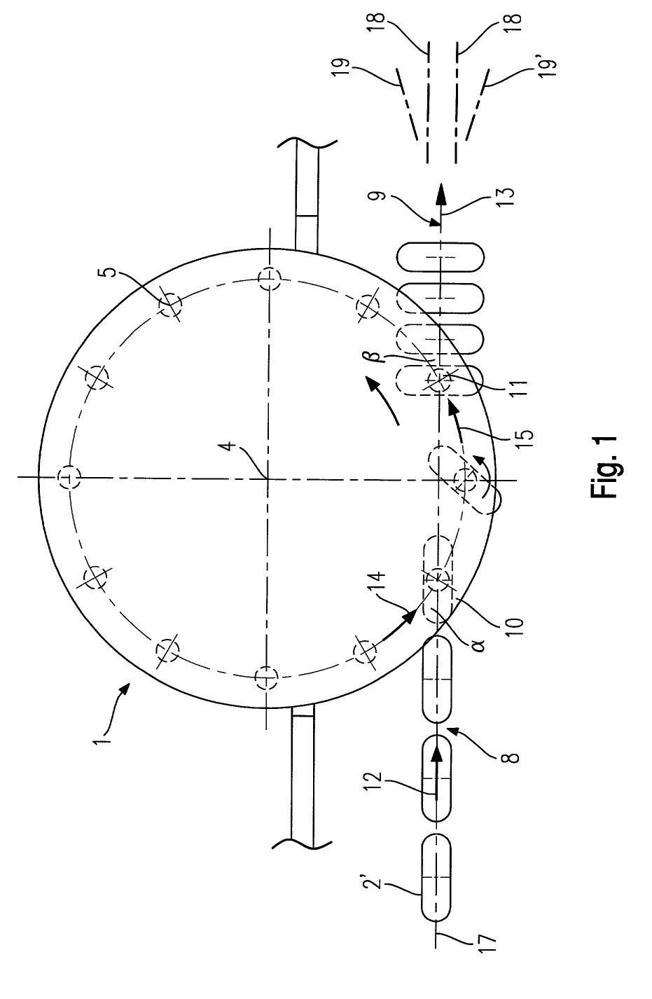

FIG. 1 shows, in a schematic diagram, a plan view with a first product;

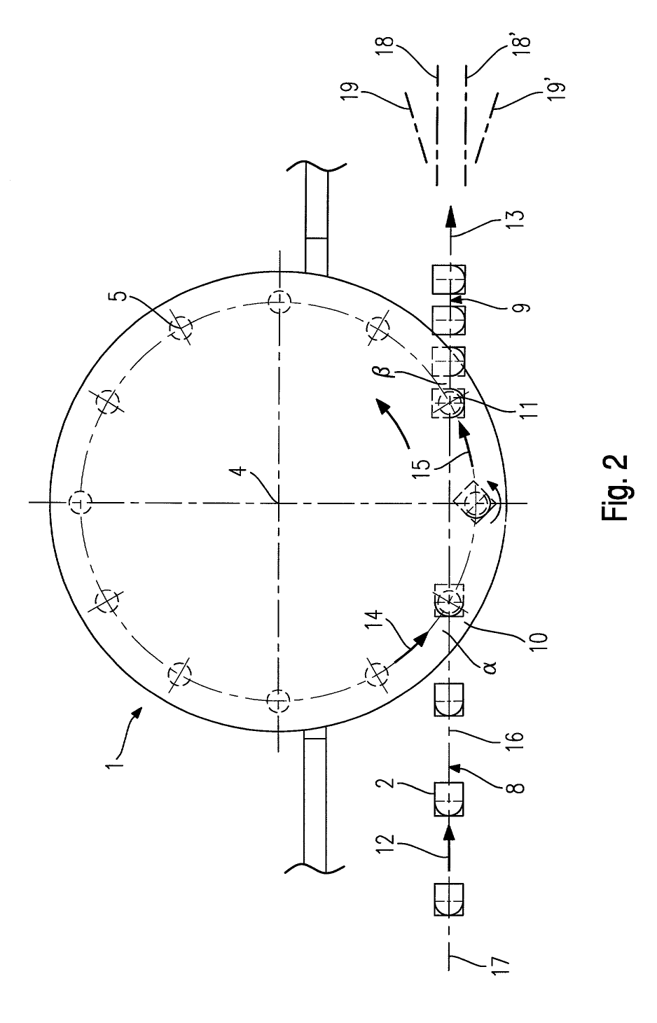

FIG. 2 shows, in a schematic diagram, a plan view with a different product;

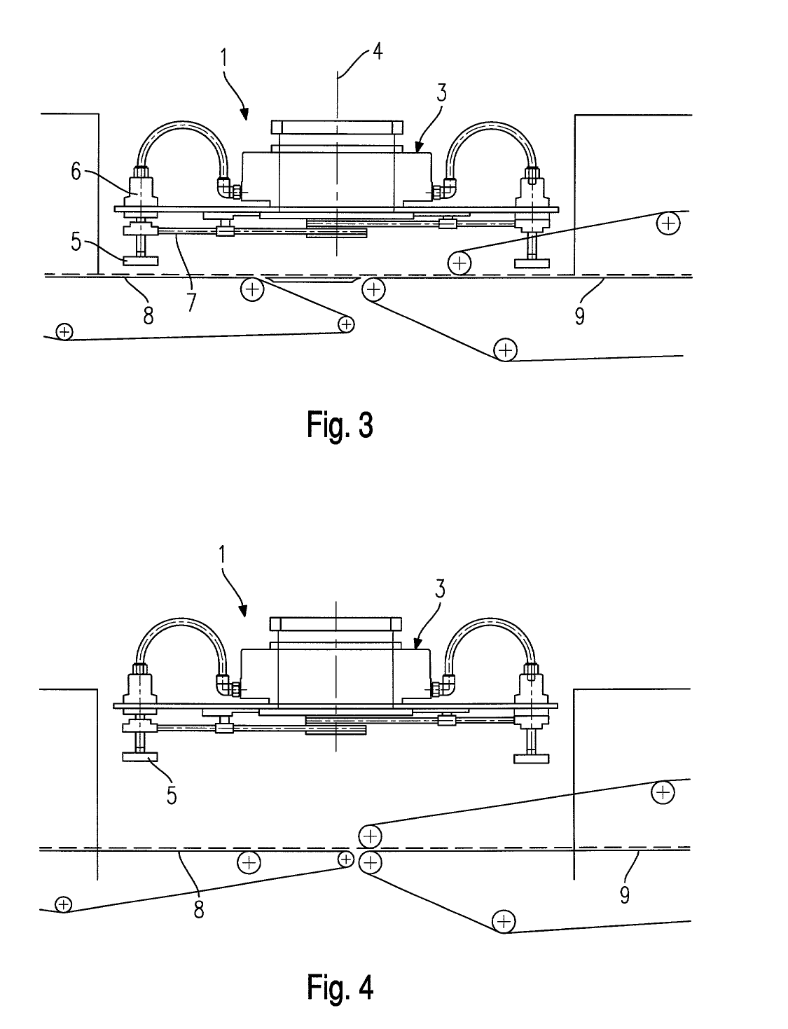

FIG. 3 shows, schematically, a side view with the rotational arrangement in a lowered position; and

FIG. 4 shows a view like that in FIG. 3 with the rotational arrangement in a raised position.

An apparatus 1 for turning usually flat products or semifinished products, which will be referred to hereinbelow merely as articles 2, comprises a rotational arrangement 3 which, in a manner which is of no further interest here, is mounted in a moveable manner, and driven, about an axis 4. The rotational arrangement 3 comprises at least one carry-along element 5, e.g. in the form of a sucker, which for its part is mounted in a moveable manner, and driven, about an axis 6 in the rotational arrangement 3. For this purpose, use is made, for example, of an endlessly circulating belt 7.

The turning apparatus 1 is also assigned a feeding transporting arrangement 8 and a continuing transporting arrangement 9. These may be of different configurations, as can be gathered from FIGS. 3 and 4. By means of a feeding transporting arrangement 8, the article 2 which is to be turned is transported directly into the receiving region and/or to the location 10 at which it is received by the carry-along element 5. In a discharge region and/or at a location 11, the carry-along element 5 transfers the article 2 to the continuing transporting arrangement 9.

In the region of the locations 10 and 11, the movement directions 12 and 13 (see arrows 12 and 13) of the two transporting arrangements 8 and 9 form an angle to the movement directions 14 and 15 of the carry-along element or elements 5. This angle is an angle other than zero. The articles 2 which are to be turned, rather than being fed tangentially to the movement direction 12 [sic] of the carry-along elements 5, are fed at an acute angle a and are discharged to the continuing transporting arrangement 9 at an acute angle β.

It is thus possible, for example, for the two transporting arrangements 8 and 9 to be arranged along a single, aligned axis 16. It is also possible, however, for the axis 18 or 18′ of a continuing transporting arrangement to be arranged parallel to the axis 16 of the feeding transporting arrangement.

Finally, it is also possible, within the context of the invention, for the axis 19 or 19′ of the continuing transporting arrangement, rather than being arranged in an aligned manner with, or parallel to, the axis 16, to be arranged at an acute angle to the axis 16. In this case, the axes 19 and 19′ are arranged at an angle other than zero and also other than 90°, as is indicated schematically in FIG. 2.

According to the illustration in FIG. 1, the articles 2′, which are relatively long, are fed to the turning apparatus 1 and then, following discharge to the continuing transporting arrangement 9, moved on at a small distance apart. According to FIG. 2, the articles 2, which are fed to the apparatus 1 at a relatively large distance apart from one another, are moved on, once they have been turned, at a small distance apart from one another by the continuing transporting arrangement 9. Both according to FIG. 1 and according to FIG. 2, the articles 2 and 2′ are rotated through 90° and, once they have been turned, move on in an aligned manner in the same direction as prior to turning.

For turning purposes, the articles 2 and 2′ are deflected from the preceding movement direction at an acute angle in each case.

The articles 2 and 2′ do not come into contact tangentially with the carry-along element 5 moving about the axis 4. Basically the same applies to the point in time of discharging the articles to the continuing transporting arrangement 9. It is thus the case that both in the receiving region 10 and in the discharge region 11, the article 2,2′ undergoes acceleration in a direction transverse to its preceding movement direction. In the receiving region 10, the article 2,2′ is transferred from the, for example, rectilinear, feeding movement direction 12 to a curved movement which is directed outward relative to said feeding movement direction and to the axis 4 of the rotational arrangement 3. In the discharge region 11, the curved movement of the carry-along element 5 of the rotational arrangement 3 relative to the continuing movement direction 13 of the articles 2,2′ is directed counter to the movement in the receiving region 10.

Finally, as gathered from comparing FIGS. 3 and 4, the rotational arrangement 3 is arranged in a vertically-adjustable manner. The carry-along elements 5 are thus located either, according to FIG. 3, directly above the transporting arrangements 8 and 9 or at a considerable distance therefrom (FIG. 4). This adjustability is expedient, in particular, when the rotational arrangement 3 is required for some products but is not required for other products. The function of the rotational arrangement 3 may thus be switched off by the vertical displacement.

1. Apparatus for turning articles (2) or products and/or semifinished products, during production and/or prior to packaging, in particular hygiene products, using a rotational arrangement (3) which has at least one carry-along element (5) which can be moved relative to the rotational arrangement (3) and receives the article (2) from a feeding transporting arrangement (8) and discharges it again to a continuing transporting arrangement (9), characterized by
an arrangement of the individual components such that
a) the movement direction (12) of the articles (2,2′) which are to be turned and are arranged on the feeding transporting arrangement (8) and the movement direction (14) of the carry-along element (5) at the point in time of, and at the location for (10), receiving the articles and
b) the movement direction (15) the [sic] articles (2) borne by the carry-along element (5) at the point in time of, and at the location for (11), transferring the articles to the continuing transporting arrangement (9) are located at an angle other than zero in each case.

2. Apparatus for turning articles according to claim 1, characterized by
an arrangement of the individual components such that the articles (2) are first of all deflected from the movement direction (12) of the feeding transporting arrangement (8) and then moved back into a movement direction which coincides with the original movement direction (12), is parallel (13) thereto or arranged at a slight angle thereto and has an axis (18,18′) or (19,19′), a pivoting movement (turning) taking place between the articles being received from the feeding transporting arrangement (8) and discharged to the continuing transporting arrangement (9).

3. Apparatus for turning articles according to claim 1, characterized in that, following transfer to the carry-along element (5), the article (2) can be moved on at an acute angle to its original, preceding movement direction.

4. Apparatus for turning articles according to claim 1, characterized in that, at the location (11) for discharging to the continuing transporting arrangement (9), the article (2) can be moved on at an acute angle to the preceding movement direction.

5. Apparatus for turning articles according to claim 1, characterized in that, following discharge to the continuing transporting arrangement (9), the articles can be moved on rectilinearly in the original movement direction.
